(19) United States
(12) Patent Application Publication
(10) Pub. No.: US 2016/0256970 A1
(43) Pub. Date: Sep. 8, 2016

(54) POSITIONING DEVICE FOR A PROCESS PLANT

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: FENG-GUO LIU, Jiashan (CN); YONG WANG, Jiashan (CN); REN-CAI HE, Jiashan (CN)

(21) Appl. No.: 14/940,700

(22) Filed: Nov. 13, 2015

(30) Foreign Application Priority Data
Mar. 4, 2015 (CN) 201510095688.0

(51) Int. Cl. B23Q 3/18

(52) U.S. Cl. CPC B23Q 3/186

(57) ABSTRACT

A positioning device is configured to position a workpiece having a location hole. The positioning device includes a supporting member for supporting the workpiece, at least one positioning member, and at least one pressing module mounted on the supporting member. Each of the at least one positioning member includes a driving portion and a locating pin coupled to the driving portion. The driving portion is operable to drive the locating pin to be stretched into the location hole. The pressing module includes a driving member and a pressing member coupled to the driving member. The driving member is used to drive the pressing member press the workpiece after the locating pin stretched into the location hole, and the driving portion is further configured to drive the locating pin move out of the location hole after the pressing member pressed the workpiece.

### FIELD

The subject matter herein generally relates to a positioning device for a process plant.

### BACKGROUND

In manufacturing process, workpieces need to be located to reduce machining errors. The workpiece defines a location hole, and a locating pin can stretch into the location hole of the workpiece, whereby the workpiece can be located.

### BRIEF DESCRIPTION OF THE DRAWINGS

Implementations of the present technology will now be described, by way of example only, with reference to the attached figures.

FIG. 1 is an isometric view of one example of a positioning device.

FIG. 2 is an enlarged view of a portion II of the positioning device shown in FIG. 1.

FIG. 3 is an isometric view of the positioning device of FIG. 1 viewed from another angle.

FIG. 4 is an isometric view of the positioning device in an operational state shown in FIG. 1.

FIG. 5 is an enlarged view of a portion V of the positioning device shown in FIG. 4.

FIG. 6 is an isometric view of the positioning device in another state shown in FIG. 4.

FIG. 7 is an isometric view of the positioning device in another state shown in FIG. 6.

FIG. 8 is an isometric view of the positioning device shown in FIG. 7 after the workpiece is processed.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releastably coupled. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a positioning device configured to position workpieces.

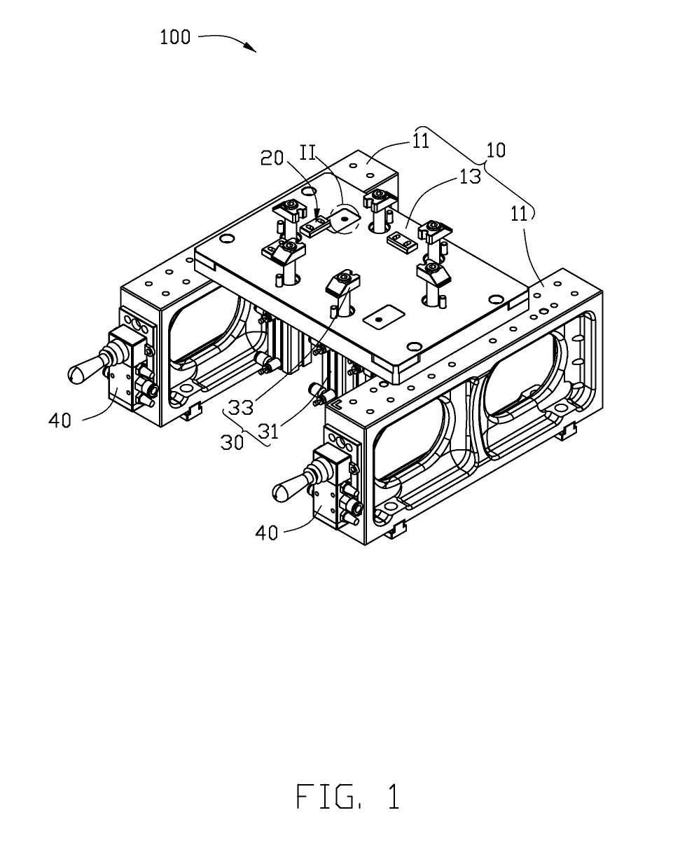

FIG. 1 illustrates that a positioning device 100 can include a supporting member 10, a locating module 20, at least one pressing module 30, and two manual valves 40. The supporting member 10 can be coupled to a processing mechanism (not shown), thereby the positioning device 100 can be coupled to the processing mechanism. The locating module 20 and the pressing module 30 can be mounted on the supporting member 10. The supporting member 10 can be substantially U-shaped and include two mounting portions 11 and a supporting portion 13. Each mounting portion 11 can be substantially rectangular shaped, and the two mounting portions 11 can be positioned facing each other.

The pressing module 30 can number six, and each pressing module 30 can include a driving member 31 and pressing member 33 coupled to the driving member 31. In at least one embodiment, the driving member 31 can be a rotating telescopic cylinder.

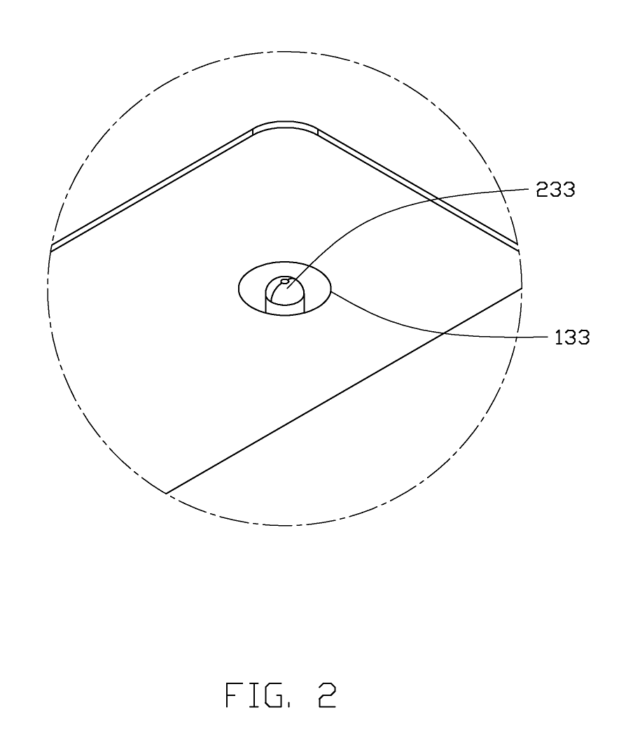

FIG. 2 illustrates that a first through hole 133 can be formed on the supporting portion 13 (shown in FIG. 1), and a locating pin 233 can stretch into the first through hole 133.

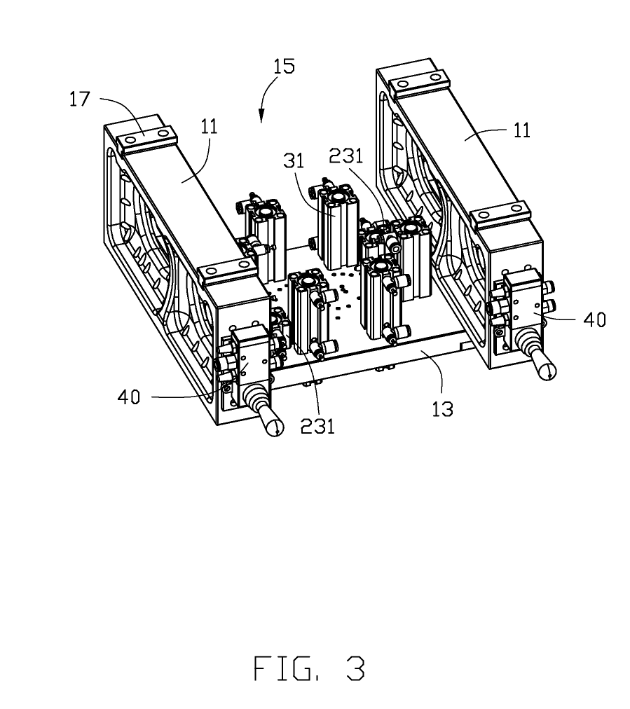

FIG. 3 illustrates that each mounting portion 11 can include an coupling portion 17 extending from one end of the mounting portion 11 away from the supporting portion 13. The coupling portion 17 can be configured to couple the supporting member 10 to the processing mechanism. In at least one embodiment, each mounting portion 11 can include two coupling portions 17, and each coupling portion 17 can be T-shaped. In other embodiments, the coupling portion can be one or more. The coupling portion 17 can also be omitted, as long as the mounting portion 11 can be coupled to the processing mechanism. The two mounting portions 11 and the supporting portion 13 can cooperatively form a substantially U-shaped accommodating space 15.

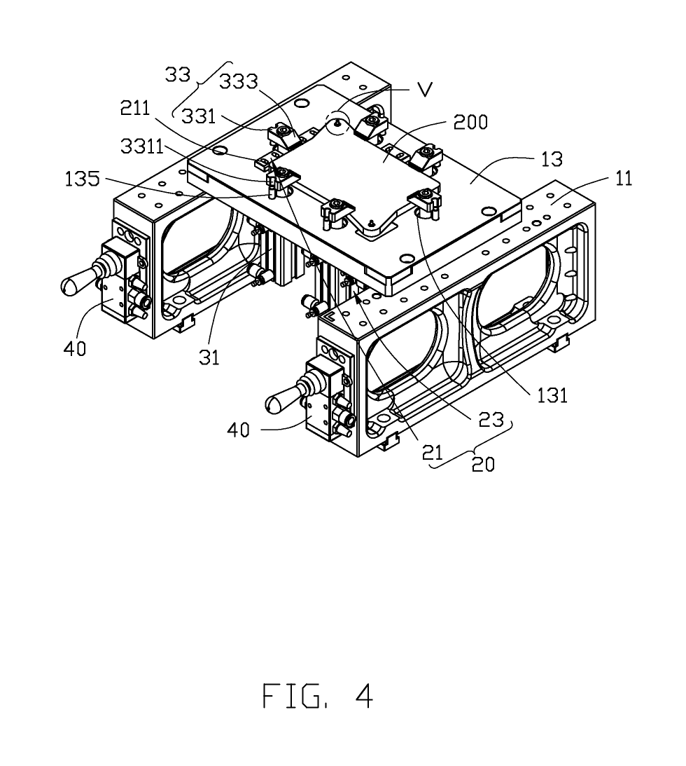

FIG. 4 illustrates that locating module 20 can include three positioning blocks 21. Each positioning block 21 can be rectangular. The positions of the three positioning blocks 21 can be adjusted. Two neighboring positioning blocks 21 can be positioned in a line, and the length direction of the other positioning block 21 can be perpendicular to the two neighboring positioning blocks 21. Each positioning block 21 can define two regulation holes 211 along the width direction thereof. In at least one embodiment, the regulation holes 211 can be elliptical. The positioning blocks 21 can be fixed to the supporting portion 13 by a fastening member (not shown). The fastening member can be coupled to the regulation holes 211, thereby the position of the positioning blocks 21 can be adjusted.

FIG. 3 and FIG. 4 illustrate that the locating module 20 can further include two positioning members 23. Each positioning member 23 can include a driving portion 231 and the locating pin 233 (shown in FIG. 2). The locating pin 233 can be coupled to the driving portion 231. In at least one embodiment, the driving portion 231 can be a cylinder 231. Each driving portion 231 can be fixed at one side of the supporting portion 13 toward the accommodating space 15 and adjacent to the corresponding first through hole 133 (shown in FIG. 2). The locating pin 233 can pass through the first through hole 133. The driving portion 231 can drive the locating pin 233 to move relative to the first through hole 133, whereby the locating pin 233 can protrude out of the corresponding first through hole 133 or received in the corresponding first through hole 133.

Each driving member 31 can be fixed at the supporting portion 13 toward the accommodating space 15. The supporting portion 13 can further define six second through holes 131, and a driving end (not shown) of each driving member 31 can pass through the corresponding second through hole 131. When the driving member 31 drives the pressing member 33 to move away from the supporting portion 13, the pressing member 33 can move in a straight line, and then the pressing member 33 can rotate about the driving end of the driving member 31, and move away from the supporting portion 13 at the same time. When the driving member 33 drives the pressing member 33 to move toward the supporting portion 13, the pressing member 33 can rotate about the driving end of the driving member 31 and move toward the supporting portion 13 at the same time, and then the pressing member 33 can move in a straight line, until the pressing member 33 presses against a workpiece 200. In at least one embodiment, a rotating angle of each pressing member 33 can be 180 degrees.

The supporting portion 13 can further include six guide protrusions 135. Each guide protrusion 135 can be positioned near the corresponding second through hole 131. The guide protrusion 135 can be column shaped. Each pressing member 33 can include a guide portion 331 and a press portion 333. The guide portion 331 can be positioned near the corresponding guide protrusion 135, and a surface of the guide portion 331 toward the guide protrusion 135 can define a curved groove 3311. A distance between a rotating shaft of the pressing member 33 and an edge of the guide end 331 is smaller than a distance between the rotating shaft of the pressing member 33 and an edge of the press end 333. When the pressing member 33 moves in a straight line, each guide protrusion 135 can be at least partially received in the corresponding groove 3311. The guide protrusion 135 can abut the guide end 331, whereby the guide protrusion 135 can guide the movement of the pressing member 33, and the pressing member 33 would not shake.

The two manual valves 40 can be mounted on the two mounting portions 11. One manual valve 40 can be used to couple an gas pipe (not shown), and the six driving members 31 can be coupled to an external gas source (not shown). The other manual valve 40 can be used to couple another gas pipe (not shown), and the two driving portions 231 can be coupled to another external gas source (not shown). Therefore, the driving members 31 and the driving portions 231 can be controlled by the two manual valves 40.

In assembling the positioning device 100, the two manual valves 40, the locating module 20, and the pressing module 30 can be mounted on the supporting member 10, and the driving portions 231 of the locating module 20 and the driving members 31 of the pressing module 30 can be received in the accommodating space 15. The driving portions 231 can be coupled to one manual valve 40 by the gas pipe, and the six driving members 31 can be coupled to the other manual valve 40, thereby the two manual valves 40 can be communicated to the external gas source.

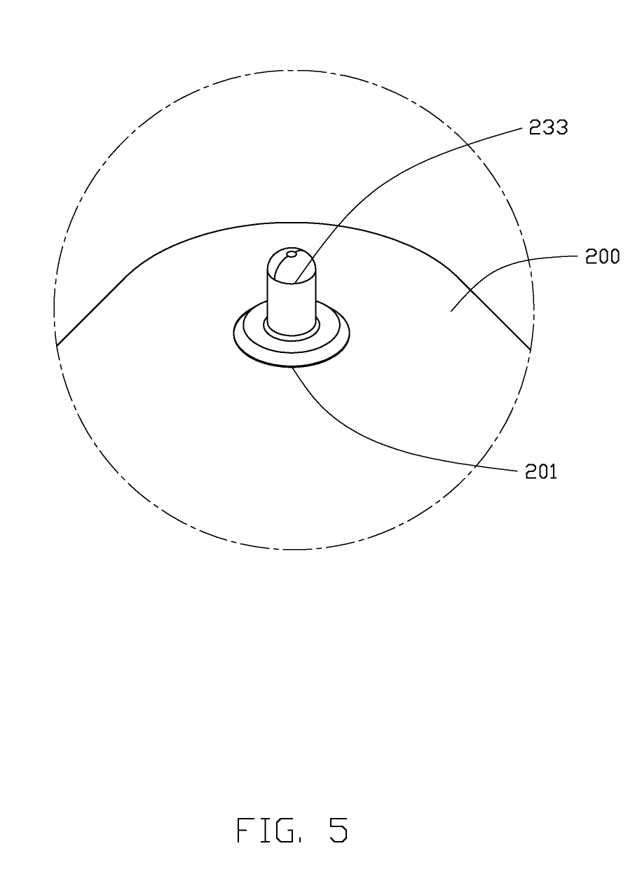

FIG. 5 illustrates that the workpiece 200 can include a location hole 201, and the locating pin 233 can be inserted to the location hole 201.

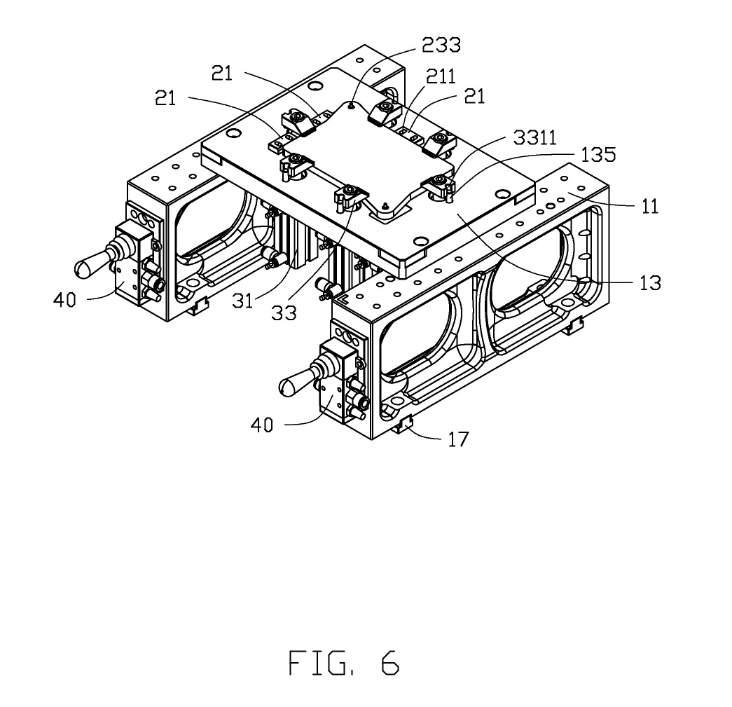

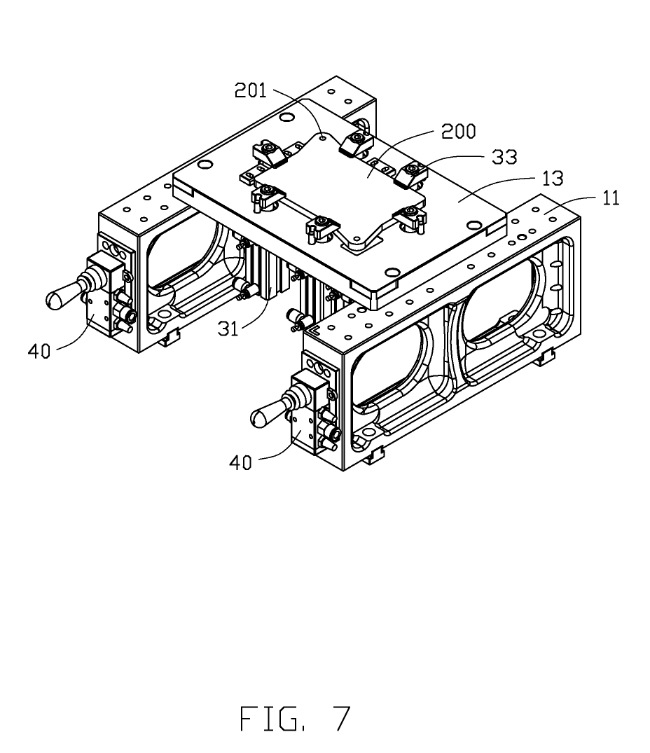

In operation, the pressing portions 333 can be positioned toward the an outer perimeter of the supporting portion 13 in an initial state, as shown in FIG. 1. The workpiece 200 can be placed on the supporting portion 13 and positioned roughly by the positioning blocks 21. As the distance between the rotating shaft of the pressing member 33 and the guide end 331 is smaller than the distance between the rotating shaft of the pressing member 33 and the press end 333, the guide end 331 would not collide with the workpiece 200. One manual valve 40 can be controlled by manual, and gas can flow to the driving portion 231. The locating pin 223 can move toward and run through the location hole 201 driven by the driving portion 231. The other manual valve 40 can be controlled by manual, and gas can flow the driving members 31. The pressing member 33 can rotate as it move toward the workpiece 200, until the pressing member 33 can not be rotated. Then, the pressing member 33 can move toward the workpiece 200 along a straight line driven by the driving member 31, thereby the workpiece 200 can be pressed by the pressing members 33, as shown in FIG. 4 through FIG. 6. The manual valve 40 coupled to the driving portion 231 can be controlled by manual again, and the locating pin 233 can move away form the location hole 201 driven by the driving portion 231. The locating pin 233 can move out of the location hole 201 and received in the corresponding first through hole 133, as shown in FIG. 7.

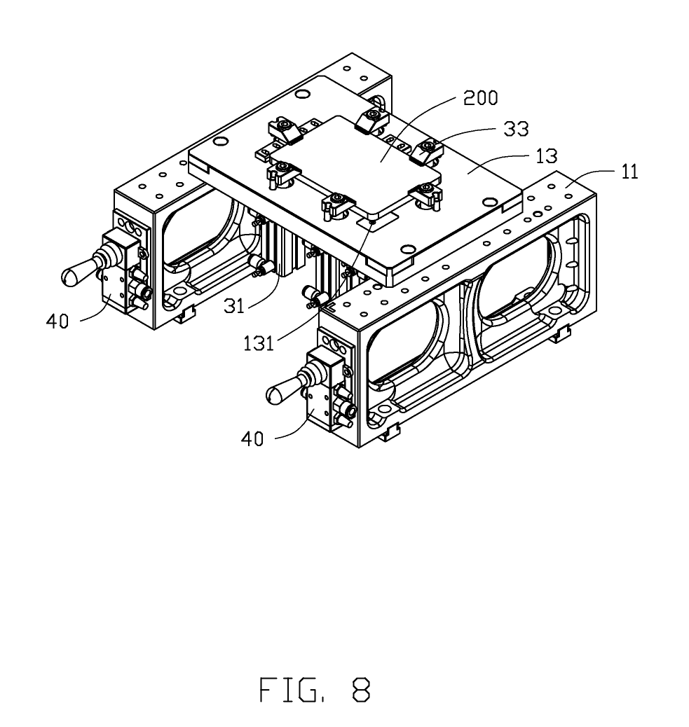

FIG. 8 illustrates that the workpiece 200 can be processed after positioned, thereby the workpiece 200 can be formed into a desired shape.

The positioning device 100 can include the locating pins 233 for locating the workpiece 200, and the pressing member 33 for pressing the workpiece 200. After the workpiece 200 is positioned, the locating pins 233 can move out of the location holes 201 to prevent mistaken processing of the locating pins 233. Therefore, the locating pins 233 can be reused, and the cost is saved. Furthermore, the guide protrusions 135 can guide the linear movement of the pressing members 33, and prevent the pressing members 33 from shaking by external interference.

In other embodiments, the pressing module 30 can be one, two, three, or more than three.

In other embodiments, the positioning member 23 can be one or more.

In other embodiments, the manual valves 40 can be replaced by automatic valves, and the positioning device 100 can include two controllers (not shown) for controlling the automatic valves. The two controllers can be electrically coupled to the automatic valves. In other embodiments, the driving portion 231 and the driving member 31 can be motors, and the manual valves can be omitted.

In other embodiments, the driving portion 231 and the driving member 31 can be other driving components, such as linear motors, as long as the driving member 31 can drive the pressing member 33 to move toward or away from the supporting portion 13.

The embodiments shown and described above are only examples. Many details are often found in the art such as the other features of a positioning device for a process plant. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A positioning device configured to position a workpiece having a location hole, the positioning device comprising:
a supporting member configured to support the workpiece;
at least one positioning member mounted on the supporting member, each of the at least one positioning member comprising:
a driving portion, and
a locating pin coupled to the driving portion, the driving portion operable to drive the locating pin to be stretched into the location hole of the workpiece; and
at least one pressing module mounted on the supporting member, each of the at least one pressing module comprising:
a driving member, and
a pressing member coupled to the driving member;
wherein the driving member is used to drive the pressing member to press the workpiece after the locating pin is stretched into the location hole, and the driving portion is further configured to drive the locating pin move out of the location hole after the pressing member pressed the workpiece.

2. The positioning device as claimed in claim 1, wherein the positioning device further comprises at least one positioning block mounted on the supporting member, the at least one positioning block defines an elliptical regulation hole, and the positioning block is adjustable on the supporting member.

3. The positioning device as claimed in claim 1, wherein the driving member is a rotating telescopic cylinder.

4. The positioning device as claimed in claim 1, wherein the pressing member comprises a guide end and a press end coupled to the guide end, the guide end defines a groove, the supporting member comprises a guide protrusion adjacent to the groove, and the guide protrusion is used to at least partially received in the groove when the pressing member moves toward the supporting member.

5. The positioning device as claimed in claim 4, wherein a distance between a rotating shaft of the pressing member and an edge of the guide end is smaller than a distance between the rotating shaft of the pressing member and an edge of the press end.

6. The positioning device as claimed in claim 1, wherein the supporting member comprises a supporting portion and two mounting portions, the two mounting portions are parallel and facing to each other, two ends of the supporting portion are mounted on the two mounting portions, the supporting portion and the two mounting portions cooperatively form an accommodating space, and the driving portion and the driving member are mounted on the supporting portion and received in the accommodating space.

7. The positioning device as claimed in claim 6, wherein one side of each mounting portion away from the supporting portion comprises a coupling portion.

8. The positioning device as claimed in claim 6, wherein the supporting portion defines a first through hole and a second through hole, the locating pin passes through the first through hole, and a part of the driving member passes through the second through hole.

9. The positioning device as claimed in claim 1, wherein the driving portion and the driving member are cylinders, the positioning device further comprises two manual valves, one manual valve is coupled to the driving member, and the other manual valve is coupled to the driving portion.

10. The positioning device as claimed in claim 1, wherein the at least one positioning member numbers two, and the at least one pressing module numbers six.
